(19) United States
(12) Patent Application Publication
(10) Pub. No.: US 2025/0028427 A1
(43) Pub. Date: Jan. 23, 2025

(54) DISPLAY CONTROL METHOD AND ELECTRONIC DEVICE USING THE SAME

(71) Applicant: ASUSTEK COMPUTER INC., TAIPEI (TW)

(72) Inventor: I-Hsi WU, TAIPEI (TW)

(21) Appl. No.: 18/487,450

(22) Filed: Oct. 16, 2023

(30) Foreign Application Priority Data
Jul. 21, 2023 (TW) 112127247

(51) Int. Cl. G06F 3/0482; G06F 3/04845

(52) U.S. Cl. CPC G06F 3/0482; G06F 3/04845

(57) ABSTRACT

The disclosure provides a display control method, adapted to an electronic device having a system, a monitoring element, and a display screen. The system has a program list. The monitoring element monitors a status of the system to generate system information. The display screen has a display region with a first side and a second side opposite to the first side, and an opening is provided at a position adjacent to the first side. The display control method includes: determining, after an application program is started, whether the application program is within a program list; and when the application program is within the program list, presenting an image generated by the application program close to the second side, and generating an auxiliary display region at a position on the display screen corresponding to the opening; and presenting all or a part of the system information in the auxiliary display region.

### CROSS-REFERENCE TO RELATED APPLICATION

This application claims the priority benefit of Taiwan Application Serial No. 112127247, filed on Jul. 21, 2023. The entirety of the above-mentioned patent application is hereby incorporated by reference herein and made a part of specification.

### BACKGROUND OF THE INVENTION

### Field of the Invention

The disclosure relates to a display control method and an electronic device using the display control method, and in particular, to a display control method adapted to a perforated screen and an electronic device using the display control method.

### Description of the Related Art

In response to a demand for thinner and lighter electronic devices (especially mobile devices), some electronic devices use a perforated screen to accommodate a front camera lens. The existence of a hole affects the integrity of a display image, and even covers some buttons, so that the buttons on the display image cannot be viewed or operated.

To solve this problem, some electronic devices shrink the display image to avoid the hole. However, this method forms an obvious black screen at a position corresponding to the hole, which affects the integrity of the image and also causes a waste of space in the image.

### BRIEF SUMMARY OF THE INVENTION

The disclosure provides a display control method, adapted to an electronic device. The electronic device has a system, a monitoring element, and a display screen. The system has a program list and is adapted to execute an application program. The monitoring element monitors a status of the system to generate system information. The display screen has a display region with a first side and a second side opposite to the first side, and an opening is located at a position adjacent to the first side. The display control method includes: determining, after an application program is started, whether the application program is within a program list; and when the application program is within the program list, presenting an image generated by the application program close to the second side, and generating an auxiliary display region at a position on the display range corresponding to the opening; and presenting all or a part of the system information in the auxiliary display region.

The disclosure further provides an electronic device. The electronic device includes a system, a monitoring element, a display screen, and a display control unit. The system has a program list and is adapted to an application program. The monitoring element monitors a status of the system to generate system information and transmit the system information back to the system. The display screen has a display region with a first side and a second side opposite to the first side, and an opening is provided at a position adjacent to the first side. The display control unit is electrically connected to the system and the display screen, and is configured to: determine, after the application program is started, whether the application program is within the program list; and when the application program is within the program list, present an image generated by the application program close to the second side, and generate an auxiliary display region at a position on the display range corresponding to the opening; and present all or a part of the system information in the auxiliary display region.

The display control method and the electronic device of the disclosure can set the display range of the application program that is likely to affect an operation due to the existence of a hole to avoid the opening, so as to improve a traditional problem that the integrity of the display image is affected by the existence of the hole. In addition, in the disclosure, the auxiliary display region is generated at the position corresponding to the opening to display relevant system information. In this way, in addition to avoiding the black screen and affecting the integrity of the image, it also effectively uses a display space at the opening to present the system information, which is convenient for a user to view.

### BRIEF DESCRIPTION OF THE DRAWINGS

FIG. 1 and FIG. 2 are a schematic block diagram and a three-dimensional diagram of an electronic device according to an embodiment of the disclosure;

FIG. 3 displays an embodiment of an auxiliary display region according to the disclosure;

FIG. 4 is a flowchart of a display control method according to a first embodiment of the disclosure;

FIG. 5 is a flowchart of a display control method according to a second embodiment of the disclosure;

FIG. 6 is a flowchart of a display control method according to a third embodiment of the disclosure;

FIG. 7 is a schematic block diagram of an electronic device according to another embodiment of the disclosure; and

FIG. 8 is a flowchart of a display control method according to a fourth embodiment of the disclosure.

### DETAILED DESCRIPTION OF THE EMBODIMENTS

The following will describe specific implementations of the disclosure in more detail with reference to drawings. According to the following description and scope of patent application, advantages and characteristics of the disclosure will be clearer. It should be noted that, drawings adopt a very simplified form and use a non-precise proportion, and are only used for conveniently and clearly illustrating embodiments of the disclosure.

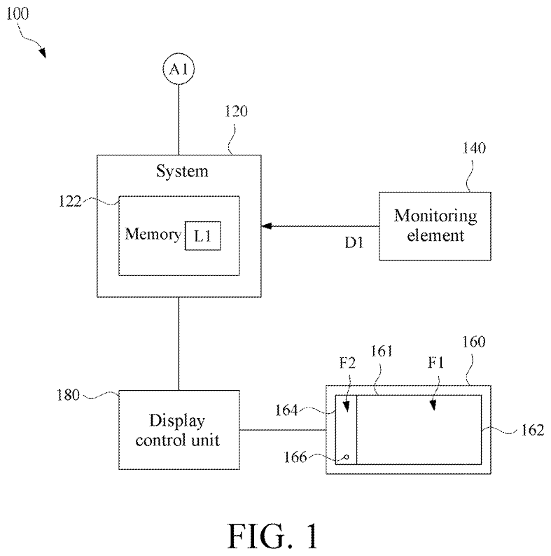

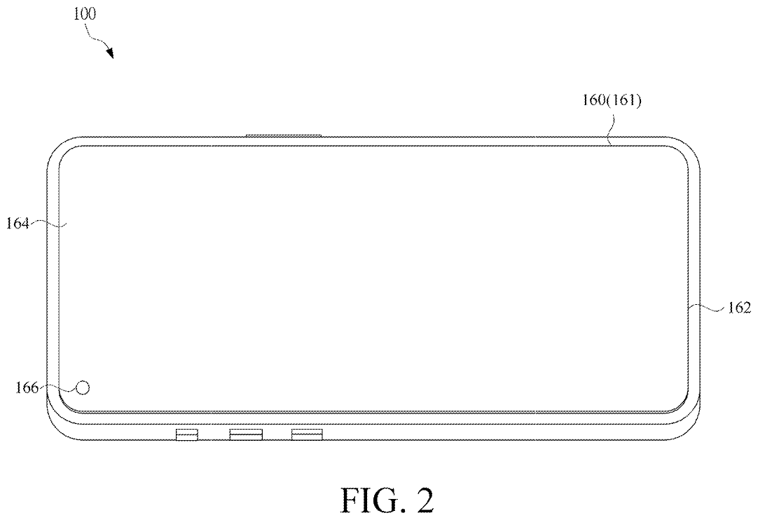

FIG. 1 and FIG. 2 are a schematic block diagram and a three-dimensional diagram of an electronic device 100 according to an embodiment of the disclosure. The electronic device 100 is a handheld electronic device, and a display screen of the electronic device 100 is provided with an opening for setting a camera lens.

As shown in the figure, the electronic device 100 includes a system 120, a monitoring element 140, a display screen 160, and a display control unit 180.

The system 120 has a memory 122, and the memory 122 stores a program list L1. The program list L1 lists at least one preset application program that needs to adjust a display image accordingly. In an embodiment, these preset application programs are game programs. In an embodiment, the system 120 is a computer system, including software and hardware. The software part is an operating system. The hardware part includes a central processing unit and a memory.

The monitoring element 140 is adapted to monitor a status of the system 120 to generate system information D1 and transmit the system information D1 back to the system 120. The system information D1 includes a system temperature, a battery level, a network status, a platform type, time and date, or a combination of the above.

In an embodiment, the monitoring element 140 is a sensing element disposed on a main board. The system 120 includes a basic input output system (BIOS) on the main board, which is connected to the monitoring element 140 to obtain the system information D1.

The display screen 160 has a display range 161. The display range 161 is a region in which the display screen 160 displays an image. The display range 161 is rectangular and has a first side 162 and a second side 164 opposite to the first side 162. The display screen 160 is provided with an opening 166 at a position adjacent to the first side 162 to facilitate the installation of a camera lens (not shown in the picture).

In an embodiment, as shown in the figure, the opening 166 is located at a corner of the display range 161. But the disclosure does not limit this. In other embodiments, the position of the opening 166 is also a middle position corresponding to the first side 162 of the display range 161. In an embodiment, the opening 166 is a circular opening.

The display control unit 180 is electrically connected to the system 120, the monitoring element 140, and the display screen 160, and is configured to control the display image of the display screen 160. In this embodiment, the display control unit 180 is an independent component outside the system 120, such as a display control chip, but it is not limited thereto. In other embodiments, the display control unit 180 is a part of the system 120.

After the system 120 receives an execution instruction to start an application program A1, the display control unit 180 determines whether the application program A1 is within the program list L1. When the application program A1 is within the program list L1, the display control unit 180 immediately presents an image generated by the application program A1 close to the second side 164, and an auxiliary display region F2 is generated at a position on the display range 161 corresponding to the opening 166.

In an embodiment, the display control unit 180 first determines an aspect ratio of an image F1 generated by the application program A1, sets a width of the image F1 to be equal to a height of the display range 161 of the display screen 160, and presents the image F1 close to the second side 164. A position not occupied by the image F1 within the display range 161 of the display screen 160 is an auxiliary display region F2.

In an embodiment, the display control unit 180 first sets a maximum width of a complete image (that is, without the opening 166 in the image) that is presented by the display range 161 according to the position of the opening 166 on the display range 161. Then, the maximum width is used to adjust a size of the image F1 generated by the application program A1. A position not occupied by the image F1 within the display range 161 of the display screen 160 is an auxiliary display region F2.

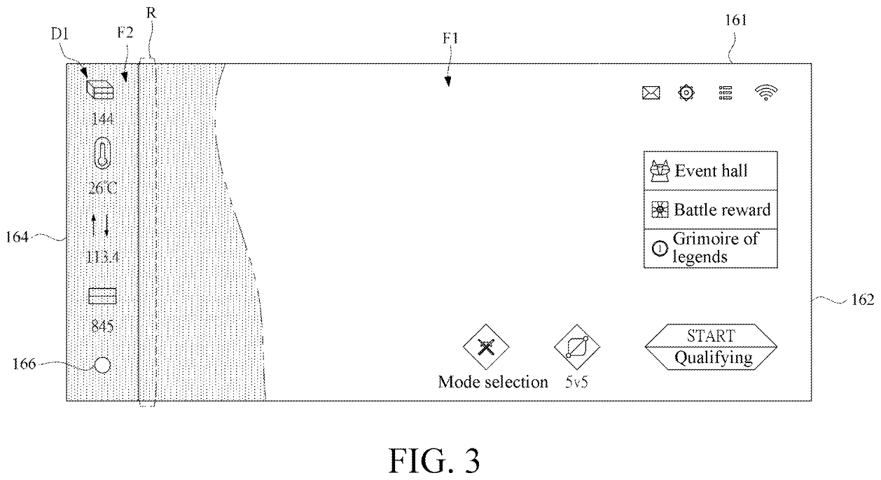

The display control unit 180 presents all or a part of the system information D1 in the auxiliary display region F2. Details about the auxiliary display region F2 are described in more detail later in the part corresponding to FIG. 3.

Referring to FIG. 3, FIG. 3 displays an embodiment of an auxiliary display region F2 according to the disclosure.

As shown in the figure, the opening 166 is located at a corner of the display range 161. The auxiliary display region F2 is rectangular, and the auxiliary display region F2 is close to a shorter side of the display range 161.

The system information D1 displayed in the auxiliary display region F2 includes a frame quantity per second, a system temperature, a network speed, and a platform type from top to bottom.

In an embodiment, a background of the auxiliary display region F2 is a single-color background, and when the display control unit 180 generates the auxiliary display region F2, the display control unit 180 defines a background color of the auxiliary display region F2 according to the image F1 generated by the application program A1.

In an embodiment, the display control unit 180 defines the background color of the auxiliary display region F2 according to the color of the image F1 generated by the application program A1. In an embodiment, the display control unit 180 detects the average color value of a range R of the image F1 adjacent to the auxiliary display region F2, and uses a color corresponding to the average color value as the background color of the auxiliary display region F2.

In an embodiment, when the display control unit 180 defines the background color of the auxiliary display region F2, the display control unit 180 also defines the color of a font or symbol used for the system information D1 to be displayed in the auxiliary display region F2.

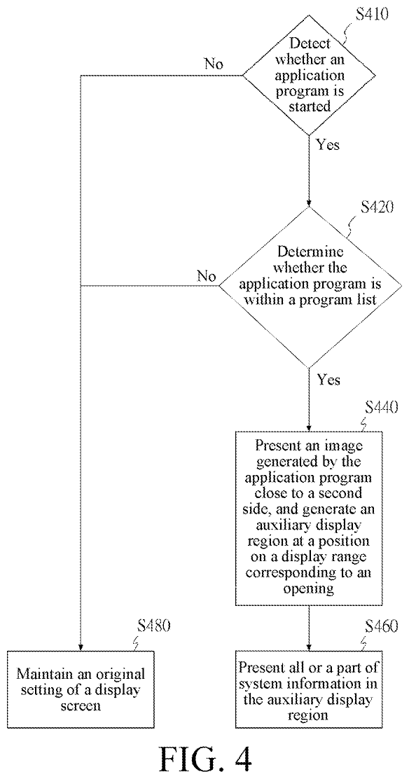

FIG. 4 is a flowchart of a display control method according to a first embodiment of the disclosure. The display control method is adapted to the electronic device 100 shown in FIG. 1 and FIG. 2, and includes the following steps.

First, as described in step S410, whether an application program A1 is started is detected.

If the application program A1 is started, the process proceeds to step S420 to determine whether the application program A1 is within a program list L1.

When the application program A1 is within the program list L1, the process proceeds to step S440, the image F1 generated by the application program A1 is presented close to the second side 164, and an auxiliary display region F2 is generated at a position on the display range 161 corresponding to the opening 166. Next, as described in step S460, all or a part of the system information D1 is presented in the auxiliary display region F2.

Following step S410, when no application program A1 is started, the process proceeds to step S480, and an original setting of the display screen 160 is maintained. Following step S420, when the application program A1 is not within the program list L1, the process also proceeds to step S480, and an original setting of the display screen 160 is maintained. In an embodiment, the original setting of the display screen 160 is that when the application program A1 is executed, the image F1 generated by the application program A1 is presented in a full-screen manner without generating the auxiliary display region F2.

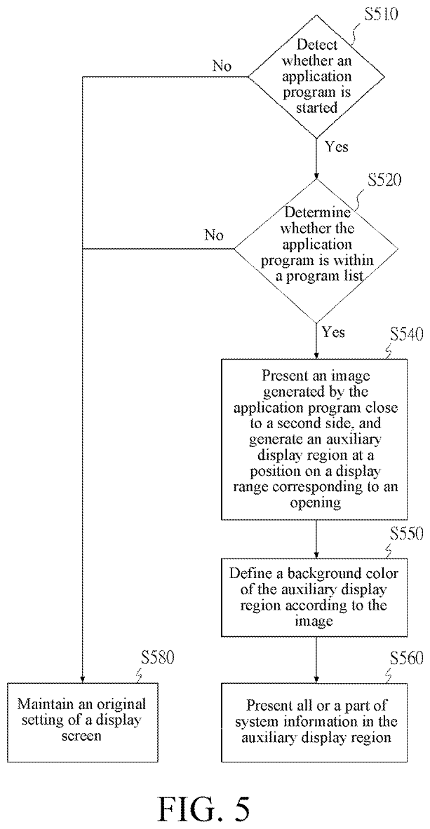

FIG. 5 is a flowchart of a display control method according to a second embodiment of the disclosure. The display control method is adapted to the electronic device 100 shown in FIG. 1 and FIG. 2, and includes the following steps.

First, as described in step S510, whether an application program A1 is started is detected.

If the application program A1 is started, the process proceeds to step S520 to determine whether the application program A1 is within a program list L1.

When the application program A1 is within the program list L1, the process proceeds to step S540, the image F1 generated by the application program A1 is presented close to the second side 164, and an auxiliary display region F2 is generated at a position on the display range 161 corresponding to the opening 166.

Next, as described in step S550, a background color of the auxiliary display region F2 is defined according to the image F1. In an embodiment, when the overall image F1 is dark, the auxiliary display region F2 is set to black. When the overall image F1 is bright, the auxiliary display region F2 is set to white.

Next, as described in step S560, all or a part of the system information D1 is presented in the auxiliary display region F2.

Following step S510, when no application program A1 is started, the process proceeds to step S580, and an original setting of the display screen 160 is maintained. Following step S520, when the application program A1 is not within the program list L1, the process also proceeds to step S580, and an original setting of the display screen 160 is maintained.

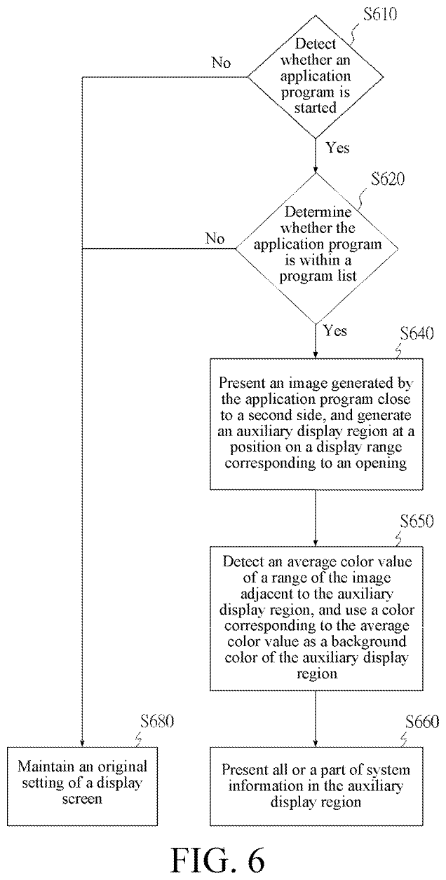

FIG. 6 is a flowchart of a display control method according to a third embodiment of the disclosure. The display control method is adapted to the electronic device 100 shown in FIG. 1 and FIG. 2, and includes the following steps.

First, as described in step S610, whether an application program A1 is started is detected.

If the application program A1 is started, the process proceeds to step S620 to determine whether the application program A1 is within a program list L1.

When the application program A1 is within the program list L1, the process proceeds to step S640, the image F1 generated by the application program A1 is presented close to the second side 164, and an auxiliary display region F2 is generated at a position on the display range 161 corresponding to the opening 166.

Next, as described in step S650, the average color value of a range of the image F1 adjacent to the auxiliary display region F2 is detected, and a color corresponding to the average color value is used as the background color of the auxiliary display region F2. In an embodiment, it is possible to detect the average color value of a column or columns of pixels closest to the auxiliary display region F2 in the image F1, and then use the color corresponding to the average color value as the background color of the auxiliary display region F2.

Next, as described in step S660, all or a part of the system information D1 is presented in the auxiliary display region F2.

Following step S610, when no application program A1 is started, the process proceeds to step S680, and an original setting of the display screen 160 is maintained. Following step S620, when the application program A1 is not within the program list L1, the process also proceeds to step S680, and an original setting of the display screen 160 is maintained.

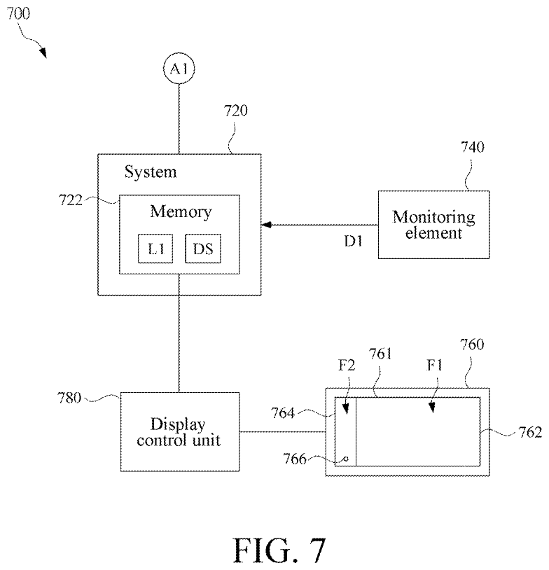

FIG. 7 is a schematic block diagram of an electronic device according to another embodiment of the disclosure.

Compared with the electronic device 100 shown in FIG. 1, in addition to storing the program list L1, the memory 722 of the system 720 in this embodiment also stores display setting data DS corresponding to the preset application program in the program list L1. Similar to the electronic device 100 shown in FIG. 1, the electronic device 700 of this embodiment also has a monitoring element 740, a display screen 760, and a display control unit 780. The display range 761 of the display screen 760 has a first side 762 and a second side 764 opposite to the first side 762, and an opening 766 is provided at a position adjacent to the first side 762.

After the display control unit 780 determines that the application program A1 is within the program list L1, the display control unit 780 presents an image F1 generated by the application program A1 close to the second side 764, and an auxiliary display region F2 is generated at the opening 766 corresponding to the display range 761. Then, the display control unit 780 presents all or a part of the system information D1 in the auxiliary display region F2 according to the display setting data DS.

In an embodiment, when the system information D1 includes a system temperature, a battery level, a network status, time and date, or a combination of the above, and the display setting data DS only has the system temperature and the battery level, the display control unit 780 only displays the system temperature and the battery level in the system information D1 in the auxiliary display region F2.

Through the setting of the display setting data DS, it is ensured that the system information D1 displayed in the auxiliary display region F2 is the system information D1 that is highly relevant to the running application program A1. In addition, too much unnecessary system information D1 can be avoided in the auxiliary display region F2. In an embodiment, when the started application program A1 is executed without being connected to the network, the corresponding display setting data DS is set as not needing to display the network status.

In addition, in an embodiment, the display control unit 780 also detects the current power supply status of the system 720, and adjusts the system information D1 displayed in the auxiliary display region F2. Specifically, when the display control unit 780 detects that the system 720 is powered by a commercial power supply instead of a battery, the display control unit 780 does not display the battery level in the auxiliary display region F2.

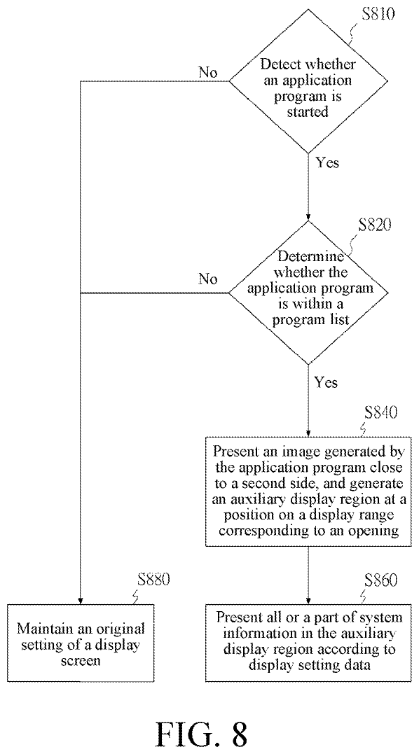

FIG. 8 is a flowchart of a display control method according to a fourth embodiment of the disclosure. The display control method is adapted to the electronic device 700 shown in FIG. 7, and includes the following steps.

First, as described in step S810, whether an application program A1 is started is detected.

If the application program A1 is started, the process proceeds to step S820 to determine whether the application program A1 is within a program list L1.

When the application program A1 is within the program list L1, the process proceeds to step S840, the image F1 generated by the application program A1 is presented close to the second side 764, and an auxiliary display region F2 is generated at a position on the display image 761 corresponding to the opening 766.

Next, as described in step S860, all or a part of the system information D1 is presented in the auxiliary display region F2 according to the display setting data DS. Following step S810, when no application program A1 is started, the process proceeds to step S880, and an original setting of the display screen 760 is maintained. Following step S820, when the application program A1 is not within the program list L1, the process also proceeds to step S880, and an original setting of the display screen 760 is maintained.

The display control method and the electronic devices 100 and 700 of the disclosure can set the display ranges 161 and 761 of the application program A1 that is likely to affect an operation due to the existence of holes to avoid the openings 166 and 766, so as to improve a traditional problem that the integrity of the display image is affected by the existence of the openings 166 and 766. In addition, in the disclosure, the auxiliary display region F2 is generated at the position corresponding to the openings 166 and 766 to display relevant system information D1. In this way, in addition to avoiding the black screen and affecting the integrity of the image, it also effectively uses a display space at the openings 166 and 766 to present the system information D1, which is convenient for a user to view.

The above are only exemplary embodiments of the disclosure but do not limit the disclosure. Variations such as equivalent replacements or modifications in any form made by any person skilled in the art to the technical means and technical contents disclosed in the disclosure without departing from the technical means of the disclosure are contents not departing from the technical means of the disclosure and still fall within the protection scope of the disclosure.

What is claimed is:

1. A display control method, adapted to an electronic device, wherein the electronic device has a system, a monitoring element, and a display screen, the system has a program list and is adapted to execute an application program, the monitoring element monitors a status of the system to generate system information, the display screen has a display region with a first side and a second side opposite to the first side, and an opening is provided at a position adjacent to the first side, and the display control method comprises:
starting the application program;
determining whether the application program is within the program list;
when the application program is within the program list, presenting an image generated by the application program close to the second side, and generating an auxiliary display region at a position on the display screen corresponding to the opening; and
presenting all or a part of the system information in the auxiliary display region.

2. The display control method according to claim 1, wherein the system information comprises one of a system temperature, a battery level, a network status, time and date, or a combination of the above.

3. The display control method according to claim 1, wherein the auxiliary display region is rectangular.

4. The display control method according to claim 3, wherein the auxiliary display region is close to a short side of the display screen.

5. The display control method according to claim 1, wherein the opening is located at a corner of the display range.

6. The display control method according to claim 1, further comprising: defining a background color of the auxiliary display region according to the image.

7. The display control method according to claim 6, wherein the step of defining the background color of the auxiliary display region according to the image comprises:
detecting an average color value of a range of the image adjacent to the auxiliary display region, and using a color corresponding to the average color value as the background color.

8. The display control method according to claim 1, wherein the application program is a game program.

9. The display control method according to claim 1, wherein the electronic device has a memory, and the memory stores display setting data corresponding to the application program.

10. The display control method according to claim 9, wherein the step of presenting all or a part of the system information in the auxiliary display region is: presenting all or a part of the system information in the auxiliary display region according to the display setting data.

11. An electronic device, comprising:
a system, having a program list and adapted to execute an application program;
a monitoring element, monitoring a status of the system to generate system information and transmit the system information back to the system;
a display screen, having a display range with a first side and a second side opposite to the first side, and an opening being provided at a position adjacent to the first side; and
a display control unit, electrically connected to the system and the display screen, and configured to:
determine, after the application program is started, whether the application program is within the program list;
when the application program is within the program list, present an image generated by the application program close to the second side, and generate an auxiliary display region at a position on the display range corresponding to the opening; and
present all or a part of the system information in the auxiliary display region.
